(19) United States
(12) Patent Application Publication
(10) Pub. No.: US 2011/0182253 A1
(43) Pub. Date: Jul. 28, 2011

(54) Mobile Mesh, Relay, and Ad-Hoc System Solution Based on WiMAX Technology

(75) Inventor: Parwiz Shekalim, Netanya (IL)

(73) Assignee: Runcom Technologies Ltd., Rishon Lezion (IL)

(21) Appl. No.: 12/867,325

(22) PCT Filed: Feb. 12, 2009
(86) PCT No.: PCT/IB09/50575

§ 371 Date: Aug. 12, 2010

Related U.S. Application Data
(60) Provisional application No. 61/027,845, filed on Feb. 12, 2008.

(51) Int. Cl. H04W 72/04; H04W 4/00; H04W 52/04

(52) U.S. Cl. 370/329; 370/328

(57) ABSTRACT

A layered network architecture for a wireless communication network. A mobile network node and/or base-station in a wireless communication network using the layered architecture. Negotiating functionality used by the network nodes and/or base-stations to negotiate layer parameters and/or cell parameters with a neighboring network nodes or base-stations.

### CROSS-REFERENCE TO RELATED APPLICATIONS

The present application claims priority from U.S. Provisional Patent Application 61/027,845, filed Feb. 12, 2008, the contents of which are hereby incorporated by reference.

### FIELD AND BACKGROUND OF THE INVENTION

The invention relates to communication systems and methods, and, particularly, to relay, mesh and ad-hoc communication system and methods using the IEEE802.16 standards and its derivatives. In this document, the term “mesh” or “mesh network”, refers also to ad-hoc and/or relay network and/or functionalities.

In this document the term WiMAX is used to denote a communication network base on any the IEEE802.16 group of standards, and particularly, but not limited to, the IEEE802.16e (and further releases IEEE802.16 Rev2 up to the most updated releases), IEEE802.16j (up the most updated releases) and IEEE802.16m standards, including all the management, operation, provisioning, interfacing and networking definitions of the IEEE802.16e/j/m.

The current WiMAX solution, or the IEEE802.16 standard, is based on fixed cell concept, and therefore does not cover mobile mesh networking, nor does it cover ad-hoc functionalities. Fixed mesh solution was defined in the early IEEE802.16d version of the standard, and removed from the standard due to complexity and lack of definitions. Obviously, since the IEEE802.16d standard is oriented for fixed networking, it did not include any provisions for mobile mesh, that is a mesh network serving mobile user terminals. US published patent applications 20080025330 and 20080130614 are believed to represent the most relevant prior art.

There is thus a widely recognized need for, and it would be highly advantageous to have, a mesh networking method and/or system devoid of the above limitations.

### SUMMARY OF THE INVENTION

According to one aspect of the invention there is provided a mobile base-station operative in a wireless communication network, where the wireless communication network includes network layers and where the mobile base-station includes negotiating functionality for negotiating at least one of a layer parameter and a cell parameter with a neighboring base-station.

According to another aspect of the invention there is provided a mobile base-station where the at least one of a layer parameter and a cell parameter includes at least one of: frequency band (F1, F2, etc.), segmentation, or sub-band (F1a, F1b, etc.), sub-carrier grouping and./or allocation, sub-carrier sub-grouping and or allocation, sub-channelization, permutation, coding, preamble ID, timing and transmission power.

According to yet another aspect of the invention there is provided a method of wireless communication in a communication network including a plurality of network nodes where at least one of the network nodes is mobile, the method including: arranging the communication network according to a layered network architecture forming a plurality of network layers, arranging the plurality of network nodes in the network layers, and assigning at least one of a network parameter and a cell parameter to at least one of the network nodes.

According to still another aspect of the invention there is provided a method where the at least one of a network parameter and a cell parameter includes at least one of: frequency band (F1, F2, etc.), segmentation, or sub-band (F1a, F1b, etc.), sub-carrier grouping and./or allocation, sub-carrier sub-grouping and or allocation, sub-channelization, permutation, coding, timing, preamble ID, and transmission power.

Further according to another aspect of the invention there is provided a method where the step of assigning at least one of a network parameter and a cell parameter to at least one of the network nodes includes negotiating the at least one of a network parameter and a cell parameter with at least one other network node.

Still further according to another aspect of the invention there is provided a method where the network node is a base-station.

Yet further according to another aspect of the invention there is provided a method where the plurality of network layers includes at least a first, a second and a third layer and additionally including at least one of the steps of: receiving, by a network node at the second layer, a data transmission from a network node is the first layer and transmitting the data transmission to a network node is the third layer; and receiving, by a network node at the second layer, a data transmission from a network node is the third layer and transmitting the data transmission to a network node is the first layer.

Even further according to another aspect of the invention there is provided a method where the network node is a relay node.

Additionally according to another aspect of the invention there is provided a method where the communication network is at least one of: an OFDMA network, a network complying to any of IEEE802.16 standards and its derivatives, a WiMAX network, and an LTE network.

Also according to another aspect of the invention there is provided a method where the communication network uses communication technology including sub-carriers and where the sub-channels are grouped to form segments, additionally including the step of allocating segments to layers to achieve frequency orthogonality between layers.

According to yet another aspect of the invention there is provided a method additionally including the steps of dividing the segment into at least two groups of sub-channels to form sub-segments, and allocating the sub-segments to the network nodes of the layer to achieve orthogonality between the network nodes.

According to another aspect of the invention there is provided a mobile node for a wireless communication network, the mobile node including: a terminal module operative to communicate with at least one of a base-station, and a base-station module of another mobile node of the wireless communication network, a base-station module connected to the terminal module and operative to communicate with a terminal module of another mobile relay and/or a user-terminal of the plurality of user-terminals of the wireless communication network, where the base-station module is operative to negotiate cell parameters with neighboring base-station modules.

Further according to another aspect of the invention there is provided a mobile relay for a wireless communication network including a plurality of user-terminals, the mobile relay including: a terminal module operative to communicate with at least one of a base-station and a base-station module of another mobile relay of the wireless communication network; and a base-station module connected to the terminal module and operative to communicate with at least one user-terminal of the plurality of user-terminals of the wireless communication network; where the mobile relay performs relay operation by performing at least one of: receiving at the terminal module, from the at least one of a base-station and a base-station module, a transmission directed to a user-terminal; and transmitting the transmission via the base-station module to the user-terminal.

Yet further according to another aspect of the invention there is provided a mobile relay where the wireless communication network is at least one of: an OFDMA network, a network complying to any of IEEE802.16 standards and its derivatives, a WiMAX network, an LTE network, a mesh network, and an ad-hoc network.

Still further according to another aspect of the invention there is provided a mobile relay where the mobile relay is additionally operative as a user terminal of the wireless communication network.

Even further according to another aspect of the invention there is provided a mobile relay where at least one of the plurality of the user terminals of the wireless communication network is additionally operative as the mobile relay.

Also according to another aspect of the invention there is provided a mobile relay where the mobile relay is additionally operative as a base station of the wireless communication network.

Additionally according to another aspect of the invention there is provided a mobile relay where the mobile relay includes a processor; where the terminal module includes a terminal software module; where the base-station module includes a base-station software module; and where the terminal software module and the base-station software module are processed by the processor.

According to yet another aspect of the invention there is provided a mobile relay where the wireless communication network is at least one of a mesh network and an ad-hoc network.

According to still another aspect of the invention there is provided a wireless communication network for at least one of ad-hoc and mesh deployment, the wireless network including: a plurality of communication layers, and at least one mesh node within at least one network layer, where the mesh node includes a user-terminal functionality and a base-station functionality.

Further according to another aspect of the invention there is provided a wireless communication network including at least one mesh node within at least one network layer where the mesh node uses communication technology including sub-carriers and complying with at least one of: an OFDMA technology, IEEE802.16 standards and its derivatives, a WiMAX technology, and LTE technology; where the sub-channels are grouped to form segments and where the segments are allocated to the layers to achieve orthogonality between layers.

Still further according to another aspect of the invention there is provided a wireless communication network including at least one mesh node within at least one network layer where the mesh nodes use communication technology including sub-channels and complying with at least one of: an OFDMA technology, IEEE802.16 standards and its derivatives, a WiMAX technology, and LTE technology; where the sub-channels are grouped to form segments and where the layers are allocated different time slots to achieve orthogonality between layers.

Yet further according to another aspect of the invention there is provided a wireless communication network where the at least one mesh node uses communication technology including sub-channels and complying with at least one of: an OFDMA technology, IEEE802.16 standards and its derivatives, a WiMAX technology, and LTE technology; where at least one layer includes at least two mesh nodes, and where the segment allocated to the layer is divided into at least two groups of sub-channels to form sub-segments and where the sub-segments are allocated to the mesh nodes of the layer to achieve orthogonality between the mesh nodes.

Still further according to another aspect of the invention there is provided a mobile base-station additionally including a permutation calculation module for calculating the permutation according to a layer number, and/or a preamble calculation module for calculating the preamble according to a layer number.

Even further according to another aspect of the invention there is provided a mobile node according additionally including a network management module.

Additionally, according to yet another aspect of the invention there is provided a frame structure for communicating data in a wireless network, the frame-structure including: a transmission sub-frame, and a receiving sub-frame, where at least one of the transmission sub-frame and the receiving sub-frame includes at least one of: a subordinate zone for receiving of data from a superordinate node, and a superordinate zone for receiving data from a subordinate node.

According to still another aspect of the invention there is provided a frame structure where the subordinate zone and the superordinate zone provide simultaneous communications in the uplink and the downlink.

Also according to another aspect of the invention there is provided a frame structure where the Tx subframe contains data transmission to a superordinate and data transmission to at least one subordinate and where a node can transmit the data to its superordinate and to its subordinate node in the same time.

Also according to another aspect of the invention there is provided a frame structure where a Tx zone contains a data transmission to a superordinate and at least one data transmission to at least one subordinate, and where a network node can transmit the data to its superordinate and to its subordinate nodes in the same time.

Additionally according to another aspect of the invention there is provided a frame structure where the TX subframe is located in a first or a second part of the frame.

Additionally according to yet another aspect of the invention there is provided a frame structure where the Tx subframe additionally contains allocations to prevent interference.

Additionally according to still another aspect of the invention there is provided a frame structure where the allocations are defined by a superordinate node for its subordinate nodes.

Further according to another aspect of the invention there is provided a frame structure where the transmission sub-frame includes at least one of: a preamble symbol, a broadcast segment, allocation resources for at least one of ACK and NACK, at least one of a control segment and a message segment, and a payload segment carrying transmission data.

Yet further according to another aspect of the invention there is provided a frame structure where the transmission sub-frame includes at least one of: a preamble, a control part preferably containing pairs of: a Frame Control Header (FCH), and at least one of broadcasting and MAP, a transmission payload part including one or more data bursts, an unused part, a Transmission Transition Gap (TTG), and a receive/transmit transition gap.

Still further according to another aspect of the invention there is provided a frame structure where the receiving sub-frame includes at least one of: a receiving preamble, a receiving MAC broadcasted section, a contention section, a payload area containing one or more data zones, a Receive Transition Gap (RTG); and a receive/transmit transition gap.

Even further according to another aspect of the invention there is provided a frame structure for communicating data in a wireless network using two frequency bands, the frame-structure including: a preamble part, a broadcast part, a transmission part, and a receive part, where a first frequency band of the two frequency bands is used for communication with at least one subordinate node, and a second frequency band of the two frequency bands is used for communication with a superordinate node.

Also, according to another aspect of the invention there is provided a frame structure additionally including: a receive part for receiving from an upper layer, a downlink preamble part for communication with a lower layer, a downlink broadcasting and frame map part for communication with the lower layer, a downlink data transmission payload part for communication with the lower layer, an uplink preamble part for communication with the upper layer, an uplink Security Association (SA) or broadcasting of frame and MAP part for communication with the upper layer, an uplink data transmission payload part for communication with the upper layer, and a receive part for receiving from the lower layer.

Additionally, according to another aspect of the invention there is provided a frame structure where at least one of the receiving sub-frame and the transmission sun-frame is located according to layer.

Additionally, according to yet another aspect of the invention there is provided a frame structure where in a first layer the receiving sub-frame is located in a first part of the frame and in a second layer the receiving sub-frame is located in a second part of the frame.

Additionally, according to still another aspect of the invention there is provided a frame structure where in a first layer the transmission sub-frame is located in a first part of the frame and in a second layer the transmission sub-frame is located in a second part of the frame.

According to yet another aspect of the invention there is provided a frame structure for communicating data in a wireless network, the frame-structure including a transmission frame, the transmission frame including: a preamble, a transmission transition gap, and one or more sections, each containing a frame control header (FCH), a transmission map, and one or more payload sections.

According to still another aspect of the invention there is provided a frame structure additionally including a receive-map and one or more payload sections.

Further according to another aspect of the invention there is provided a frame structure for communicating data in a wireless network, the frame-structure including a receiving frame, the receiving frame including: a receiving preamble part, a transmission transition gap (TTG), a contention area, and one or more payload sections.

Yet further according to another aspect of the invention there is provided a frame structure additionally including at least one of a unicast transmission and a multicast transmission.

Also, according to another aspect of the invention there is provided a method for calculating permutation P according to

$${P}_{j} = if ( mod ( J , 2 ) == 0 ) {〈}_{{P}_{j - 1}}^{mod ( {P}_{j - 1} + 1 , 3 )} \vert J > 1$$

where j denotes the mesh-node layer, where j==1 is the first (root) layer, and p denotes the base-station (superordinate) permutation.

According to yet another aspect of the invention there is provided a method for calculating preamble P according to Preamble=P+Level*16+Subordinateᵢ where i is a subordinate index defined by a superordinate in subordinate initial network entry; and 16 can be any suitable number.

According to still another aspect of the invention there is provided a method for calculating path resource according to

$$Reff = {\sum }_{i = 1}^{n} \frac{1}{{RFQ}_{i}} ,$$

[Slots/byte] where Reff is number of slot cost 1 byte to transmit all the path, RFQ is number of bytes per slot transmitted between two units, depending on C2N at a channel between them, and n is number of hops in the path (Level 1).

Additionally, according to another aspect of the invention there is provided a method for calculating Obstruct Node function according to

$$R\_obst = min ( \frac{R\_free \_slot}{SonUnit \cdot nb\_nbr \cdot ( max Level - level\_nb + 1 )} )$$

where R_free_slot is slot free to the transmit a message depend on the numbers of unit associated to the test unit and the neighbors interference, SonUnit is number of offsprings, nb_nbr is number of neighbor units, maxLevel is number of levels in branch (lower layer), and level_nb is unit level.

Further according to another aspect of the invention there is provided a method for calculating PRICE Function according to PRICE=(nb_hop×Reff)/R_obst, where Nb-hop is number of hops in the path, Reff is number of slot cost 1 byte to transmit all the path, and R-obst is Obstruct Node function as defined above.

Unless otherwise defined, all technical and scientific terms used herein have the same meaning as commonly understood by one of ordinary skill in the art to which this invention belongs. The materials, methods, and examples provided herein are illustrative only and not intended to be limiting. Except to the extend necessary or inherent in the processes themselves, no particular order to steps or stages of methods and processes described in this disclosure, including the figures, is intended or implied. In many cases the order of process steps may varied without changing the purpose or effect of the methods described.

Implementation of the method and system of the invention involves performing or completing certain selected tasks or steps manually, automatically, or any combination thereof. Moreover, according to actual instrumentation and equipment of embodiments of the method and system of the invention, several selected steps could be implemented by hardware or by software on any operating system of any firmware or any combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the embodiments of the invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a is simplified illustration of a layered network architecture for mobile mesh networks;

FIG. 2 is a simplified illustration of a cooperative mesh network architecture;

FIG. 3 is a simplified illustrations of a standalone mesh-network;

FIG. 4 is a simplified illustrations of an externally connected mesh-network;

FIG. 5 is a simplified illustration of a single frequency mode frame structure;

FIG. 6 is a simplified diagram of a transmission sub-frame structure for single frequency mode;

FIG. 7 is a simplified diagram of a receive sub-frame structure for single frequency mode;

FIG. 8 is a simplified diagram of a single frequency mode frame structure for frequency reuse of less than 1;

FIG. 9 is a simplified illustration of a layered network architecture for mobile mesh networks operating in dual frequency mode;

FIG. 10 is a simplified diagram of a dual frequency mode frequency orthogonal frame structure;

FIG. 11 is a simplified diagram of an example of Tx frame allocation;

FIG. 12 is a simplified diagram of an example of frame allocation in Rx mode;

FIG. 13 simplified diagram of a mesh network PHY topology;

FIG. 14 is a simplified diagram of a slot request in a mesh network;

FIG. 15 is a simplified block diagram of a switching configuration; and

FIG. 16 is a simplified block diagram of another switching configuration.

### DETAILED DESCRIPTION OF THE INVENTION

The principles and operation of a method and system for implementing a mesh communication network over a WiMAX communication system according to the invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

WiMAX is the name of an organization which main purpose is to promote the IEEE802.16 standard and to coordinate interoperability among vendors of equipment using the IEEE802.16 standard. The term WiMAX also defines some specific profiles out of all defined profiles in the IEEE802.16 family of standards. However, in this document the term WiMAX refers to any version of the IEEE802.16 standard and particularly to the versions applicable for mobile communications, such as the IEEE802.16 Rev2 (may also be known as 802.16e, IEEE802.16j and IEEE802.16m). Furthermore, all the management, operation, provisioning, interfacing and networking definitions of the IEEE802.16 family of standards are applicable for the purpose of this document and for the mesh solution described herein.

Mesh networking is a common name for a family of communication technologies in which one network terminal communicates with another network terminal directly or via other network terminals (and not necessarily through base stations in the case of wireless communication networks). Mobile mesh networking is also know as ad-hoc networking and refers to mesh networking where the network terminals are mobile. Therefore, in mesh networks the network terminals also function as communication relays, or ad-hoc relays, and in mobile mesh networks the network terminals also function as mobile relays and/or ad-hoc nodes. Hence, in this document, the term mesh refers to all three types of mesh networks and relay terminals, including but not limited to mobile mesh, ad-hoc and relay.

In this document, the term mesh node refers any network node that includes functionalities of a user terminal (including user station (UT), subscriber station (SS), mobile station (MS), Customer Premises Equipment (CPE), etc.) and/or functionalities of a base station (BS), and also includes relay and/or mesh and/or ad-hoc functionalities. Optionally, the mesh node may also include ASN-GW functionalities (for example, as described by the WiMAX Forum).

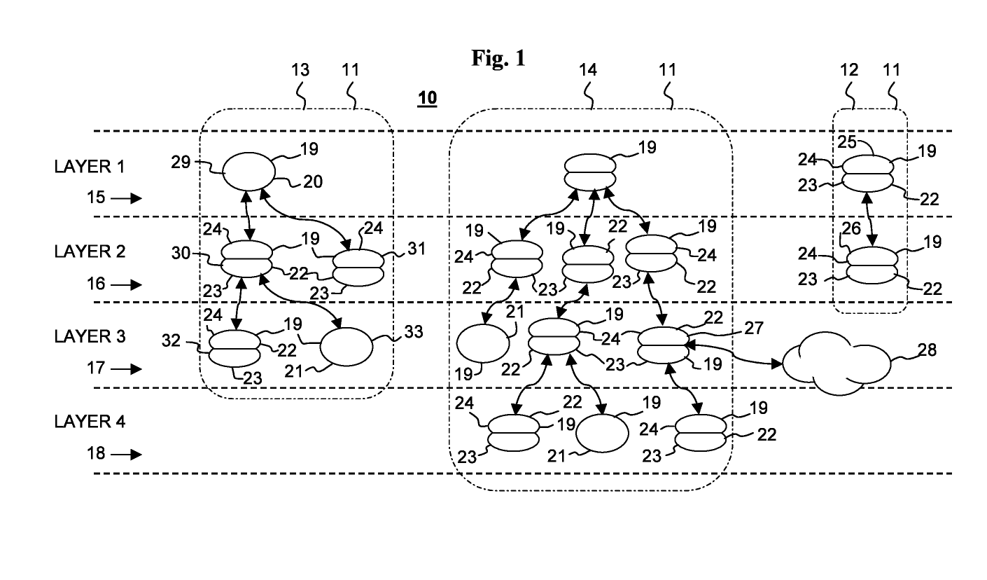

Reference is now made to FIG. 1, which is simplified illustration of a layered network architecture 10 for mobile mesh networks 11 according to an embodiment of the invention.

FIG. 1 shows three mobile mesh networks 12, 13, and 14, using the layered network architecture 10. For example, FIG. 1 shows a mobile mesh architecture containing four network layers 15, 16, 17 and 18. It is appreciated that the layered network architecture 10 can accommodate any number of layers.

As seen in FIG. 1, a mobile mesh network is preferably spread over a plurality of layers. For example, mobile mesh network 12 is spread over layer 1 and layer 2, designated by numerals 15 and 16, respectively. Mobile mesh network 13 is spread over layer 1, 2 and 3, designated by numerals 15, 16, and 17 respectively. Mobile mesh network 14 is spread over layer 1, 2, 3 and 4, designated by numerals 15, 16, 17, and 18 respectively.

Preferably, the nodes are automatically designated to different logical layers, with each node designated to a single logical layer. Preferably, each node tries to designate itself to the uppermost layer, if possible, in order to decrease the number of hops when traffic flows in the network.

The layered network architecture 10, and consequently the mobile mesh networks 12, 13, 14, typically contain three types of network nodes 19, or nodes 19 with any of three types of functionalities. Alternatively, the network node 19 may provide one or all of the following functionalities at any time:
base-stations 20;
terminal units 21; and
mesh-nodes 22.

A mesh-node 22 (MN) can be a mobile mesh-node 22 or a fixed mesh-node 22. Preferably, a mesh-node 22 has the functionality of both a base-station and a terminal unit. Mesh-nodes 22 can therefore communicate with other nodes in the network such as terminal units 21 and base-stations 20. Moreover, mesh-nodes 22 can communicate with each other directly, or via one or more other mesh-nodes 22, preferably in a peer-to-peer mode.

The base-stations 20 and the terminal units 21 are optional in the mesh network 11. The base-station 20 is typically a network node 19 providing base-station functionality only. The base-station 20 can therefore be mesh node 22 providing base-station functionality only. Alternatively, the base-station 20 may contain only a base-station module or only base station functionality. Typically, the mesh node 20 has no superordinate.

The terminal unit 21 is typically a network node 19 containing only terminal unit functionality of the mesh node 22. Preferably, a terminal unit 21 does not have any subordinate. Preferably, the mesh node 22 can function as a base station and/or as a user terminal and/or as a mesh node.

It is appreciated that a network node 19, as well as the base-station 20, the user-terminal 21 and the mesh-node 22, can be implemented as a stand-alone unit (such as a handset) and/or as a plug-in unit (such as a PCMCIA card for a laptop computer or a PDA), or any other form factor. Generally, there is no limitation on the form factor for implementation of mesh nodes.

It is appreciated that a terminal unit 21 can be a regular mobile station without meshing functionalities, and that a base-station 20 can be a regular base-station, without meshing functionalities.

In this document the term mesh-node can be written as MN, the term terminal-unit can be written as MS (for mobile station) and the term Base-station may be written as BS.

As seen in FIG. 1, the typical mesh-node 22 preferably contains two main components:
a superordinate module 23; and
a subordinate module 24.

Preferably, a superordinate module 23 of a mesh-node 22 of a first layer communicates with a terminal unit 21 residing in a lower layer, or with a subordinate module 24 of another mesh-node 22 residing in a lower layer. Accordingly, a subordinate module 24 of a mesh-node 22 communicates with a base-station 20 residing in a higher layer, or with a superordinate module 23 of a mesh-node 22 residing in a higher layer. Preferably, a superordinate module 23 can communicate with a plurality of subordinate module 24 and/or terminals units 21. Preferably, a subordinate module 24 can communicate with a single superordinate module 23 and/or base-station 20 at any given time.

It is appreciated that a subordinate module 24 can communicate with a plurality of superordinate modules 23 and/or base-stations 20 to select one of them or to effect hand-over between superordinate modules 23 and/or base-stations 20 (also know as hand-off or roaming).

In the layered network architecture 10 an upper layer is superordinate of the next lower layer, which is subordinate of the upper layer. There is no limitation on the number of layers, however each layer may contribute some delays or overhead. More layers can be defined as needed, preferably dynamically, preferably in a self-configuring function. The system preferably manages a minimum number of layers to minimize delays, overheads and traffic congestion.

Fixed base-stations preferably reside in the first layer (or root layer) of the network and serve as a superordinate of the second layer.

Preferably, each mesh-node 22 can change its layer according to the radio coverage quality, number of hops and/or any other criteria enabled by the system. However, the system algorithm may enable prioritization of some mesh node types in order to be preferably higher layer in the network, e.g. a fixed BS may preferably be prioritized to reside in the first layer, or a mesh node with more capability, such as enhanced antenna capabilities, nay be prioritized for a higher layer. It is appreciated that a mesh network such as mesh networks 12, 13 and/or 14 can use a communication technology such as:
an OFDMA technology,
a communication technology complying with the IEEE802.16 standards and their derivatives;
a WiMAX technology;
LTE technology.

Such mesh network is termed here WiMesh.

A layer is typically characterized by layer parameters, preferably containing:
Frequency band (F1, F2, etc.);
Time orthogonally mechanism to avoid interference;
Segmentation, or sub-band (F1a, F1b, etc.);
sub-carrier grouping and./or allocation;
sub-carrier sub-grouping and or allocation;
sub-channelization;
permutation;
coding;
preamble ID;
transmission power.

A WiMesh network is preferably a hierarchical network containing two or more layers (or hops). Layer 1 is the higher layer in the network, and layer N is the lowest layer in the network, when N is the last layer in the hierarchy. In the case that 1<n<64, layer 1 is the root and layer 64 is the lowest layer. Layer 1 preferably contains at least one network node that synchronize (in frequency and time) its subordinate mesh-nodes 21, in all the lower layers in the network. Several types of mesh nodes can reside in the same layer.

The layered network architecture 10 can be configure as a single network when at least one node of each network is superordinate or subordinate of other nodes. Each network may be connected to another communication network, or a control and management system, or external security system, or any external application system, or to any service provider as will be described below. Preferably, one of the fixed nodes with BS functionality is connected to an external system. However, any node can be connected to a host or any external communication network.

As seen in FIG. 1, the mesh network 12 contains two network nodes 19, both being mesh nodes 22, both containing superordinate module 23 and a subordinate module 24. In the mesh network 12 the communications between the mesh nodes 22 is preferably provided between the superordinate module 23 of the mesh node 22 designated by numeral 25 and the subordinate module 24 of the mesh node 22 designated by numeral 26.

Optionally, the superordinate module 23 of the mesh node 26 transmits signals enabling a subordinate module 24 of a third mesh node 22 to join mesh network 12 as a subordinate of mesh node 26. Optionally, the subordinate module 24 of the mesh node 25 is seeking signals transmitted by a superordinate module 23 of another mesh node in order to link to it.

It is appreciated that the relationships between mesh nodes is arbitrary. This means that, for example in the mesh network 12, any of the two mesh node 22 can assume the superordinate role while the other assumes the subordinate role. For example, the mesh node 22 of mesh network 12 can be ordered according to their BS ID.

Internet, backbone or host connectivity can be provided at any layer in the network and multiple connections are possible. That is, more than one network node 19 may have Internet and/or backbone and/or host connection. As seen in FIG. 1, mesh-node 22 designated by numeral 27 provides connectivity to Internet/backbone/host 28.

A mesh node 22 may include an interface and connectivity to a local host to enable transmitting and receiving of data, voice and any enabled application with a user. In this regard the host is a local application processor with which the mesh node 22 is associated. For example, the local host can be a computer, a laptop computer, a PDA, an application processor of a cellular telephone, etc. The mesh node 22 can be implemented as a plug-in card or device such as a PCMCIA device, or it can be integral with the host processor such as with cellular handsets. Such mesh node 22 may have a host interface and can therefore enable the used of the host as a terminal for any network-based application.

Each mesh-node 22 is preferably connected to the highest layer according to the logical topology and its neighboring mesh-nodes 22 topology. Each subordinate mesh-node 22 implements network entry to a superordinate mesh-node 22 in a higher layer, and locks its time and frequency to this superordinate node according to the close loop feedback mechanism. Distance from the superordinate may be synchronized as well, in order to synchronize “Timing Advance”. After completing the “network entry” procedure (for example: based on, but not limited to, the IEEE802.16 procedure) the superordinate mesh-node 22 starts to transmit as a base-station to its subordinate mesh-nodes 22, that operate as terminal units.

As seen in FIG. 1, node 29 in layer 1 (designated by numeral 15) is superordinate of nodes 30 and 31 in layer 2 (designated by numeral 16), and node 30 of Layer 2 is superordinate of nodes 32 and 33 of layer 3 (designated by numeral 17).

A mesh network using the layered network architecture 10 can preferably operate in a standalone mode, cooperative mode and/or externally managed mode as described below.

It is appreciated that a cooperative network, that is, a network operating in the cooperative mode, can also operate in the standalone mode or in the externally managed mode.

In the standalone or autonomous mode the mesh system or network is self-configuring. This means that the standalone network includes the required management functions, typically as a part of its nodes, and preferably within each of its nodes. Thus, the standalone network is able to configure itself automatically and/or autonomously as a self-configuring, self-managing and/or self-organizing network. Network configuration typically includes the setting or allocation of frequency bands and sub-bands (segmentation), permutations, preamble IDs, transmission power, timing, etc. Typically, a standalone network does not communicate with other networks or external application servers, etc'. The standalone (or autonomous) network operates in an ad-hoc manner without an external management or control system and configuring itself autonomously.

It is appreciated that a node may handed-over between standalone networks, and that several standalone networks may synchronize each other and configure a larger standalone network, which include all or part of the nodes from the previous networks.

It is appreciated that while standalone networks do not communicate with each other, this is typically because these networks do not receive each other's signals or adequate radio coverage in a manner that enable them to communicate. This typically means that no node of one network can communicate with any node of the other network. However, typically, if the two standalone network can communicate with each other, they would typically automatically reconfigure themselves to form a single network.

The mesh networks 12, 13 and/or 14 of FIG. 1 are standalone mesh networks. This mode is mostly applicable to secured communication, or when fixed base-stations are not applicable, or just some mobile nodes are in radio coverage of each other such as in a battlefield.

A base-station 20 or a superordinate module 23 of a mesh-node 22 in a standalone (or autonomous) network (such as networks 12, 13 and 14) is preferably capable of self-configuring. Typically, a base-station 20 or superordinate module 23 in a standalone (or autonomous) network does not require installation, and does not have a backhaul channel (other than an optional uplink channel to a superordinate node). Being capable of self-configuring means that each node is capable of negotiating layer parameters and/or cell parameters with its neighbors. Such layer parameters and/or cell parameters are typically: frequency band, timing, segmentation, or sub-bands, sub-carrier grouping and./or allocation, sub-carrier sub-grouping and or allocation, sub-channelization, permutation, coding, preamble ID, etc.

Preferably, a self-configuring node is seeking a superordinate node that enables the self-configuring node to climb to a higher layer, thus the self-configuring (autonomous) network is seeking to reduce the number of layers, preferably without creating a bottleneck.

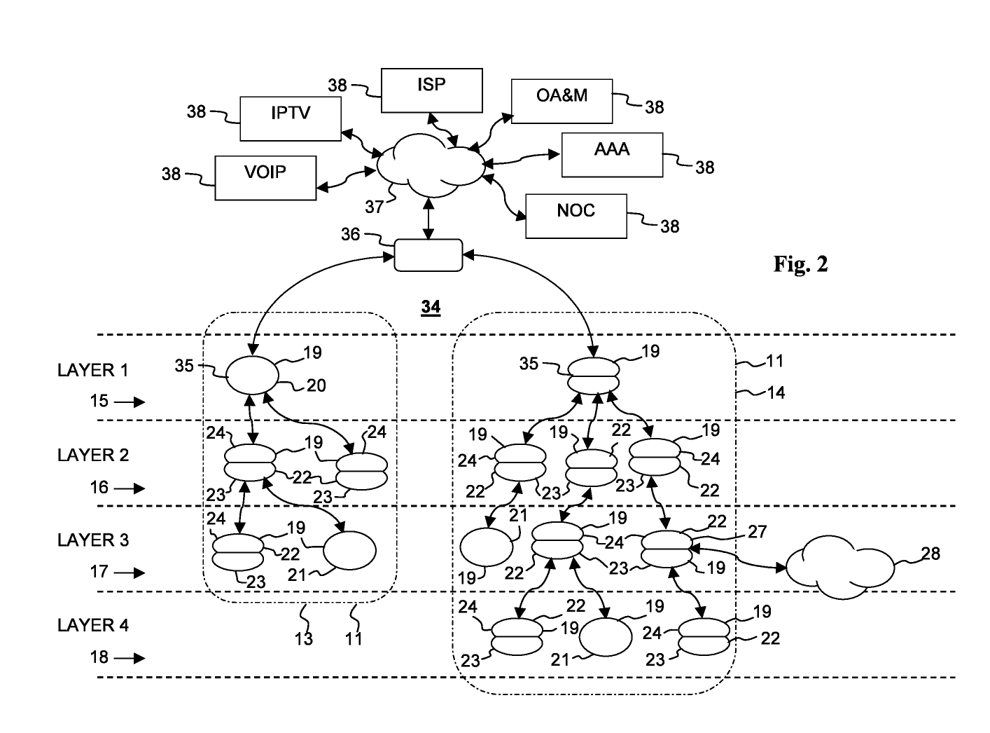

Reference is now made to FIG. 2, which is a simplified illustration of a cooperative mesh network architecture 34 according to an embodiment of the invention.

The cooperative mesh network architecture 34 is useful to connect a mesh to external networks and/or services and/or applications such as voice over Internet protocol (VoIP), Internet Protocol Television (IPTV), broadcasting services, the Internet, operations, administration, and maintenance (OA&M) offices, authentication, authorization and accounting (AAA) center, network operations center (NOC), etc.

It is appreciated that the cooperative network can also be a standalone network where the nodes are self-configuring.

As seen in FIG. 2, one or more mesh networks 11 preferably include a root node 35, preferably connected directly, or via one or more routers/switches, or via one or more Access Service Network (ASN) Gateway 36, that connects via an external network 37 to one or more external networks and/or services and/or applications 38.

Preferably, a mesh node 22 receives and transmits in the same frequency with its subordinate or superordinate peer nodes. However any mesh node 22 may operates in two different frequencies with its subordinate and its superordinate nodes. Two modes of operations are available:
single frequency mode—where only a single frequency band (channel bandwidth) is used;
dual frequency mode—where two different frequency bands are used by the mesh node 22, a first frequency band for communication with the subordinate nodes, and a second frequency band for communication with the superordinate node.

It is appreciated that while only two different frequency bands are used by each mesh node, more than two frequency bands may be used in the network.

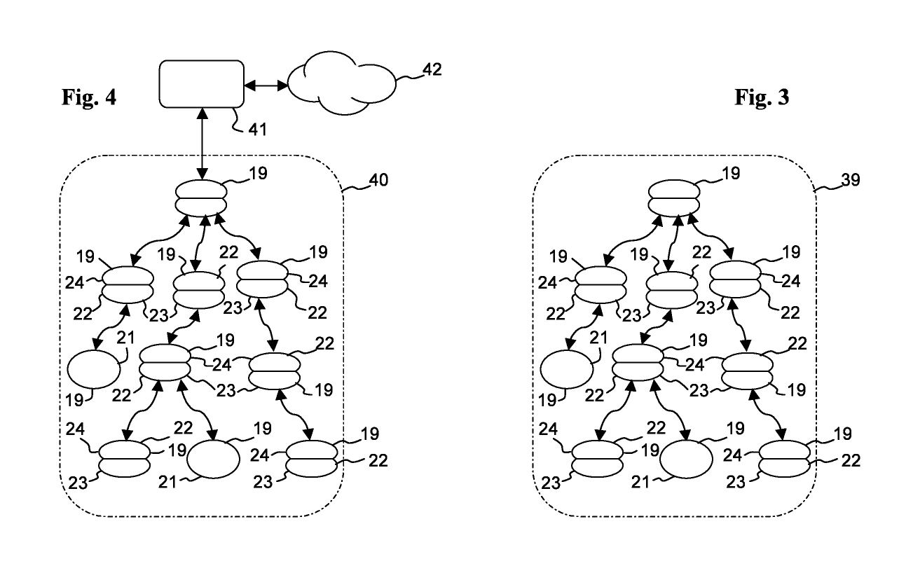

Reference is now made to FIGS. 3 and 4, which are, respectively, a simplified illustrations of a standalone mesh-network 39, and an externally connected mesh-network 40, according to an embodiment of the invention. Both networks 39 and 40 may be self-configuring.

The standalone network 39 is preferably self-configuring, as there is no connection to any external network, application, management, etc. Network 39 may continue operating in this mode, or connect to an outside entity, as illustrated in mesh-network 40 of FIGS. 4, which, for example, connects to a gateway 41 and an external network 42.

It is appreciated that the self-configuring of the autonomous network and the external network management of the externally-managed mesh-network include the setting and/or allocation and/or assigning of layer parameters and/or cell parameters are described above. Preferably, nodes of the two networks are capable of self-configuring via automatic negotiation of the layer parameters and/or cell parameters between the network nodes. Preferably, in an externally-managed mesh-network, the external network management may provides part of the setting and/or allocation and/or assigning of layer parameters and/or cell parameters according to the network map.

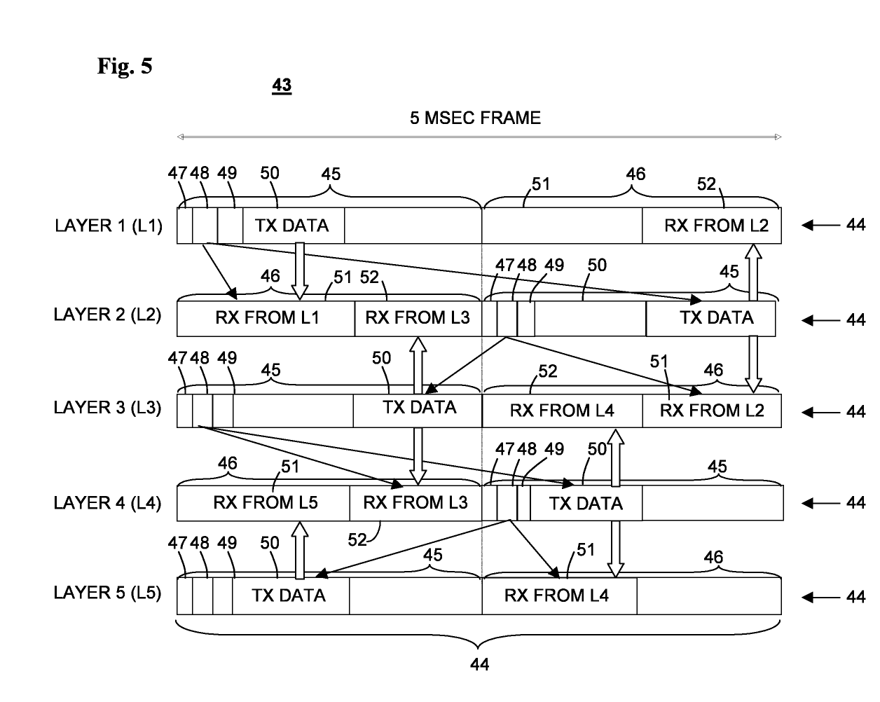

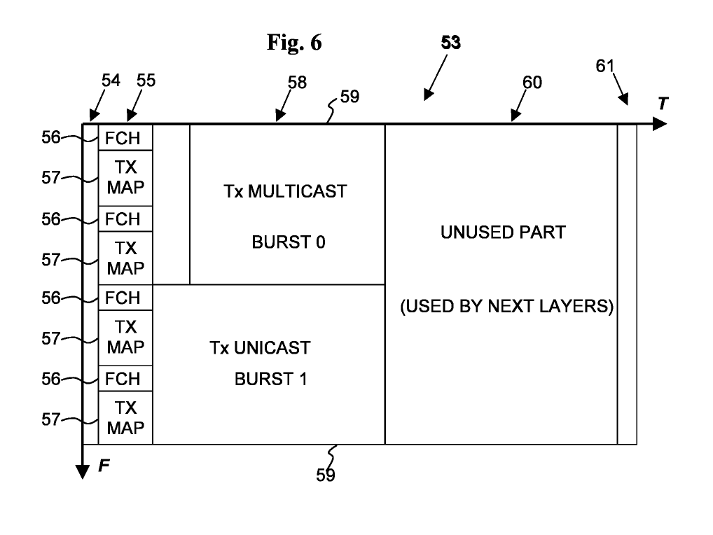

Reference is now made to FIG. 5, which is a simplified illustration of a single frequency mode frame structure 43, according to an embodiment of the invention.

Single frequency mode preferably uses time division orthogonally. FIG. 5 shows a frame structures of the different layers in a single frequency mode. The downlink and uplink data is multicasted or unicasted to the subordinate and/or superordinate modules of the mesh-nodes. Each frame 44 contains two or more sub-frames. In the case of two subframes frame:
a transmission sub-frame (Tx sub-frame) 45—indicated by the preamble as the first symbol; and
a receiving sub-frame (Rx sub-frame) 46.

The transmission sub-frame 45 is used to transmit preamble and broadcast messages, such as downlink and uplink MAP, to its subordinate nodes, and transmission of data to its superordinate and subordinate nodes. The transmission sub-frame 45 preferably contains a preamble symbol 47, a broadcast segment 48, an ACK/NACK and/or other control/messages segment 49, and a payload segment 50 carrying transmission data.

The transmission subframe in FIG. 5 shows the preamble and messages broadcast to the subordinate nodes in the lower layer. The arrows show the related messages referred to the subordinate nodes.

The Rx sub-frame 46 receives the CDMA, ACK/NACKs, feedback and other messages from a subordinate node, and receives data from one or more subordinate nodes and from a single superordinate node. Each subordinate node synchronizes itself with the received preamble or signal and broadcast MAP from its superordinate node.

Preferably, a superordinate node may define allocations for its subordinate nodes when the allocations done in the Tx subframe, and the TX subframe located in the first or second part of the frame. The arrows shows the relevant allocations defined by the superordinate node for its subordinate nodes.

Each receiving sub-frame 46 is preferably divided in at least two zones. A subordinate zone 51 is used for receiving of data from the superordinate node, and the superordinate zone 52 is used for receiving data from a subordinate node. One or several subordinate zones may be configured in the receiving sub-frame. Preferably, there is no transmission from any subordinate node when there is a transmission of preamble from its superordinate node.

A superordinate node (operating in either single frequency mode or dual frequency mode) is preferably aware of all its subordinate nodes. Thus, a superordinate node knows which subordinate nodes are directly synchronized with itself. Furthermore, each node is preferably aware not only of all its direct subordinate nodes, but is also aware of the subordinate nodes of its subordinates nodes and so on. This information can be achieved by each superordinate from its subordinate, since according to WiMAX technology, every superordinate (BS) is aware of its subordinates (MS). Hence, the list of subordinates from the lower layer can be sent to the upper layer up to layer 1 (or root layer). In this manner, every node is aware of its direct subordinates, or subordinates which are under its subordinates and so on. Furthermore, various protocols such as routing protocols, UDP, ARP, etc may be used for identification of the nodes topology in the network.

The superordinate nodes preferably transmit the data to their relevant subordinates. The relevant subordinate node, in this respect, is the node to which the transmitted date is addressed (the addressed node or destination node). The addressed node can be a direct or indirect subordinate of the transmitting node. In other words, the superordinate node preferably transmit the data to its relevant subordinate node, which may be the addressed node or a direct or an indirect superordinate of the addressed node. In the case that the communicated node (the relevant node) is a direct or an indirect superordinate of the addressed node, the communicated node is a relay node.

It is appreciated that in the case of an uplink transmission, according to WiMAX technology, every subordinate (MS) knows its direct superordinate (BS). Therefore, if the data is not addressed to its direct or indirect subordinates, then the subordinate should transmit the data to its superordinate.

There are three typical routing modes for the superordinate node to access the destination node:
known route;
unknown route; and
relevant route.

In the known route mode the superordinate maintains a complete map of its direct and indirect subordinate nodes and therefore knows the route to the destination node.

In the unknown route mode the superordinate has no knowledge of its indirect subordinate nodes and therefore it has to broadcast or multicast the data to all its direct subordinates.

In the relevant route mode the superordinate maintains a list of its direct and indirect subordinate nodes according to its direct subordinate. The superordinate node knows to which direct subordinate node to send the data, though it does not know how the network is organized thereafter.

The data flow or messages or signaling may be originated from other nodes, and/or from a host, and/or from an external network and/or from a external node and/or from an application server, etc. The data flow described below includes different type of data, such as video, voice, signaling, etc.

When a mesh-node receives data in the downlink, two scenarios may occur:
The downlink data is addressed to the mesh-node itself, the mesh-node decodes the data and may forward it to its upper protocol layers in the MAC.
The data is addressed to a subordinate mesh-node and the mesh-node forwards the data to the addressed subordinate node, or to a subordinate node that is a direct or an indirect superordinate of the addressed node.

When a mesh-node receives data in the uplink (from its subordinate), two scenarios may occur:
The uplink data is addressed to the mesh-node itself. The mesh-node decodes the data and may forward it to its upper protocol layers in the MAC.
The data is addressed to one or more other nodes. The mesh-node sends the data accordingly to its superordinate in the higher layer or other subordinates in the lower layers.

The data may be transmitted in two different modes:
As a unicast data using CID
As a multicast data using MCID

In the case of multicasting, the data (PDU—Packet Data Units) is preferably downloaded using MCID (as multicasting) to the relevant subordinate nodes, or uploaded to its superordinate node as a unicast or multicast transmission using MCID (Multicast CID) or CID. If the received PDUs belong to the receiving node (the assigned MAC or IP address of the frames/packets belong to the receiving node), then the PDU will be transferred to the upper layer of MAC protocol and will not be transmitted to the network's upper or lower layers. If the MAC or IP address of the received PDU belong to other mesh-nodes that are in the networks lower layers of the receiving node, then the received PDU is multicasted again to its relevant subordinates. In case the MAC or IP address of frames or packets do not belong to the receiving node, or do not belong to any subordinate node, then the PDUs are discarded. In this way only the referred mesh-nodes decode and pass the data.

In the case of unicasting, data is transmitted as unicast using CID as described in IEEE802.16. The PDUs are allocated using unicast IEs (Information Element as defined by IEEE802.16) and the received PDUs are decoded according to the allocations and CIDs as broadcasted in the MAP. The receiving nodes forward the PDUs to their relevant subordinate nodes or to their superordinate node if the PDUs belong to these nodes.

Reference is now made to FIG. 6, which is a simplified diagram of a transmission sub-frame structure 53 for single frequency mode according to an embodiment of the invention.

The transmission sub-frame structure (Tx Sub-frame) 53 shows a structure of a transmission transmitted by a mesh-node 22 of FIG. 1 or 2.

As seen in FIG. 6, the Tx Sub-frame 53 preferably contains:
a preamble 54;
a control part 55 preferably containing pairs of:
   Frame Control Header (FCH) 56; and
Broadcasting/MAP 57;
a transmission payload part 58 preferably containing one or more data bursts 59;
an optional unused part 60; and
Transmission transition gap (TTG) 61.

Different data bursts 59 can serve for different purposes and/or applications such as multicasting and unicasting.

The unused part 60 may be used by mesh-nodes of other layers, preferably a subordinate or a superordinate node of the mesh-node transmitting the Tx Sub-frame. In this example, the available spectrum bandwidth is divided to 4 segments (4 times FCH and MAP is used), however one or more segments can be configured.

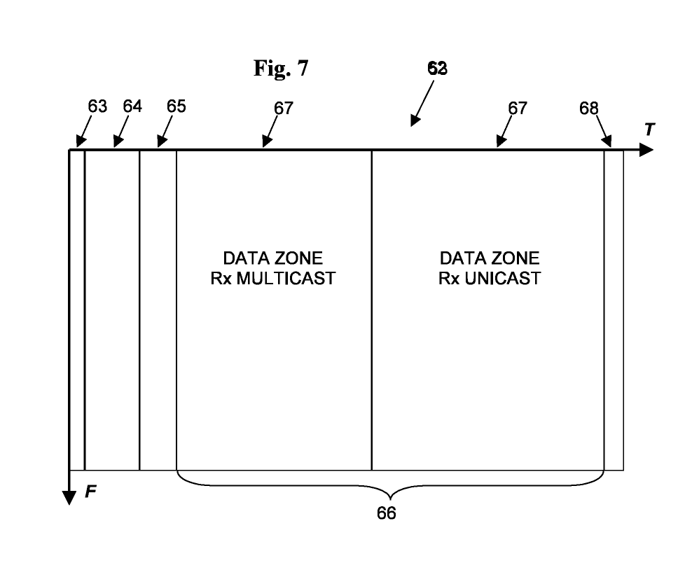

Reference is now made to FIG. 7, which is a simplified diagram of a receive sub-frame structure 62 for single frequency mode according to an embodiment of the invention.

As seen in FIG. 7, the receive sub-frame structure 62 contains:
a receiving preamble 63;
a receiving MAC broadcasted section 64;
contention section 65 (e.g. slotted ALOHA)
payload area 66 preferably containing one or more data zones 67;
Receive Transition Gap (RTG) 68.

Different data zones 67_can serve for different purposes and/or applications in multicasting and unicasting modes.

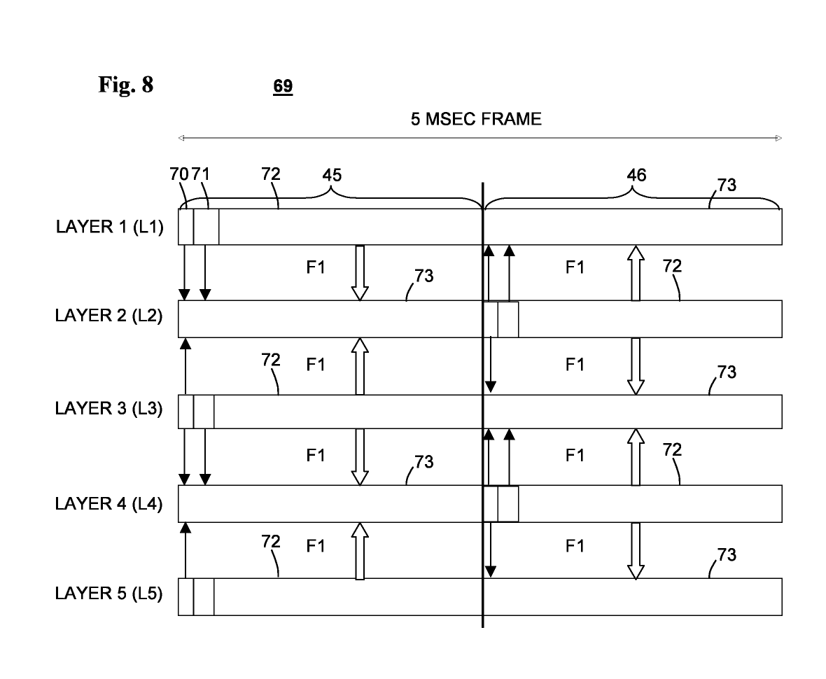

Reference is now made to FIG. 8, which is a simplified diagram of a single frequency mode frame structure 69 for frequency reuse of less than 1, according to an embodiment of the invention.

Frame structure 69 uses a single frequency channel with frequency reuse of less than 1, e.g. reuse ⅓. In this scenario transmission interference is decreases by sub-channel segmentation, by configuring different major groups of sub-channels and allocating the sub-channels groups to mesh-nodes of different layers.

Sub-channelization techniques can be used as well in order to decrease the interference between the nodes in the same logical layer. Sub-channelization involves configuring minor groups of sub-channels within the major groups, or segments.

As seen in FIG. 8, frame structure 69 preferably includes a preamble 70, a broadcast part 71, a transmit part 72, and a receive part 73.

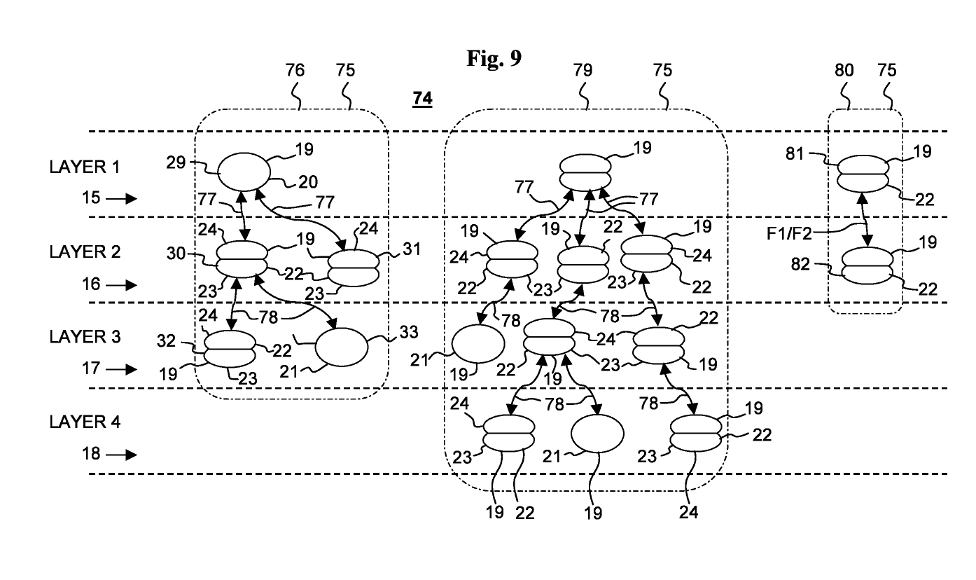

Reference is now made to FIG. 9, which is a simplified illustration of a layered network architecture 74 for mobile mesh networks 75 operating in dual frequency mode according to an embodiment of the invention.

FIG. 9 is similar to FIG. 1 except for the frequency allocation. In FIG. 9, the mesh networks 75 operate in dual frequency mode, by using two frequency bands F1 and F2 in each node. Preferably, more than two frequency bands may be used. However, each node preferably uses two frequencies F1 and F2, which are preferably different.

By way of example, in mesh network 76 the frequency band F1, designated by numeral 77, is allocated for the communication between node 29 and nodes 30 and 31. Consequently frequency band F2, designated by numeral 78, is allocated for the communication between node 30 and nodes 32 and 33. Alternatively, frequency band F1 is allocated for communication between layer 1 (15) and layer 2 (16), while frequency band F2 is allocated for communication between layer 2 (16) and layer 3 (17).

The mesh network 79 solves frequency-space-node problems in the following way:
Mesh-node super-ordinate and subordinate units use difference frequencies.
Mesh-node super-ordinate uses different permutation according to Eq. 1.
Mesh-node super-ordinate uses different preamble id according to Eq. 2.

By way of another example, in mesh network 80 nodes 81 and 82 may use either F1 or F2.

Preferably, the receiving and the transmitting frequencies are different.

As soon as one of the nodes executes hand-over from a first superordinate node to a second superordinate node all its associated subordinate nodes may change their frequency bands accordingly.

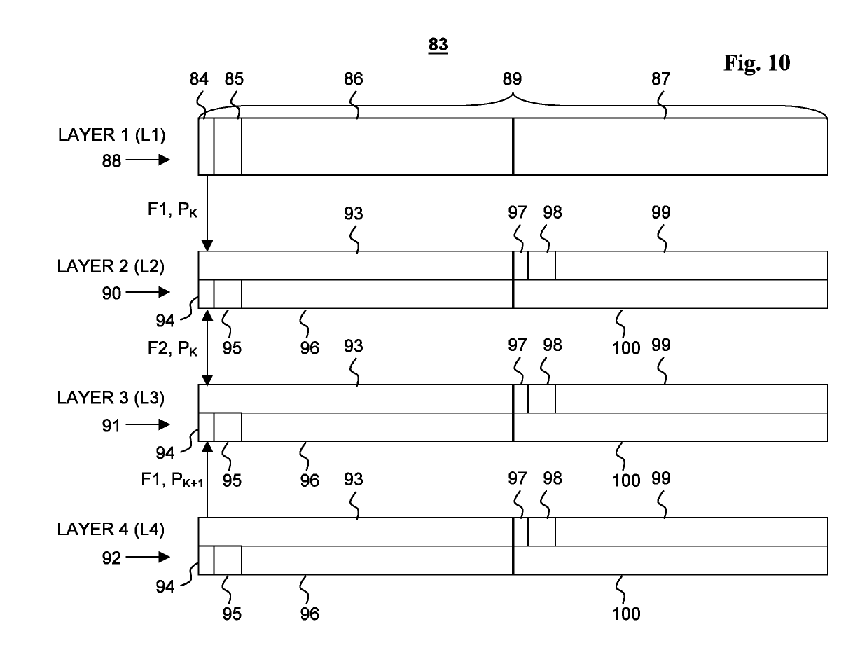

Reference is now made to FIG. 10, which is a simplified diagram of a dual frequency mode frequency orthogonal frame structure 83 according to an embodiment of the invention.

As seen in FIG. 10, the dual frequency mode frequency orthogonal frame structure 83 preferably has a basic structure preferably containing:
a preamble part 84;
a broadcast part 85;
a transmission part 86; and
a receive part 87.

While the in the root layer 1 (L1) 88 the frame structure 89 has the above structure, in subsequent layers, such as layers 2, 3 and 4 (90, 91, and 92 respectively) of FIG. 10, the dual frequency mode frequency orthogonal frame structure 83 has a more elaborated structure preferably containing:
a receive part 93 for receiving from an upper layer;
a downlink preamble part 94 for communication with a lower layer;
a downlink broadcasting and frame map part 95 for communication with the lower layer;
a downlink data transmission payload part 96 for communication with the lower layer;
an uplink preamble part 97 for communication with a upper layer;
an uplink Security Association (SA) or broadcasting of frame and MAP part 98 for communication with the upper layer;
an uplink data transmission payload part 99 for communication with the upper layer;
a receive part 100 for receiving from a lower layer.

A mesh-node using dual frequency orthogonal mode preferably uses two frequency bands F1 and F2. Each mesh-node preferably includes two main parts and/or functions and/or modules: a base-station (superordinate) function and/or module and a user terminal (subordinate) function and/or module. The mesh-node works in TDD mode using either the F1 or F2 frequency bands. Preferably, each one of superordinate and subordinate parts of has an RF unit that supports a single frequency band (e.g. 1.5 GHz, 2.5 GHz, 3.5 GHz and so on) with adequate bandwidth (e.g. 10 MHz). A separation of adequate spectrum (e.g. 50-100 MHz) is required between F1 and F2 to avoid interference between the two parts of the mesh-node.

The IEEE802.16e standard defines a downlink (DL) frame and an uplink (UL) frame. Several permutations and orthogonal preambles are allocated to each logical layer in order to reduce interference from transmission of the superordinates in the same frequency.

When using dual frequency orthogonal mode a superordinate mesh-node and a subordinate mesh-node use different frequency bands.

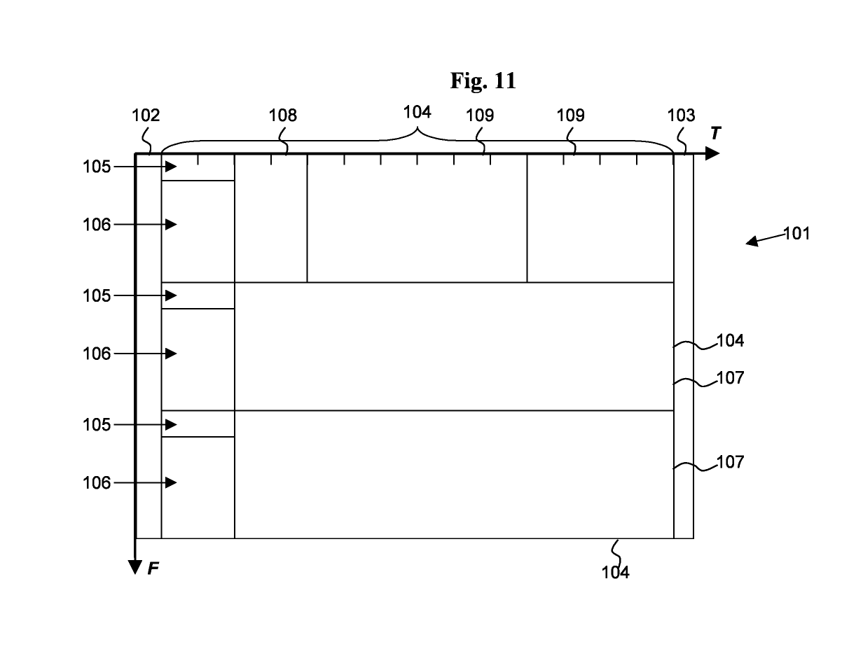

Reference is now made to FIG. 11, which is a simplified diagram of an example of Tx frame allocation according to an embodiment of the invention.

As seen in FIG. 11, the Tx frame 101 contains the following allocations:
a preamble 102 (PUSC ⅓) at the beginning and a transmission transition gap (TTG) 103 at the end;
one or more sections 104, each containing a frame control header (FCH) 105, a transmission map 106 and one or more payload sections 107.
Optionally a receive map 108 and one or more payload sections 109.

Preferably, the Tx frame is used for dual frequency frame structure. As the unadjusted layers use segmentation according to the equations below. For example: layer 1 and layer 3 have the same frequency F1, but different partitioning/segments. That is, different major groups (segments) are used in layer 1 and 3.

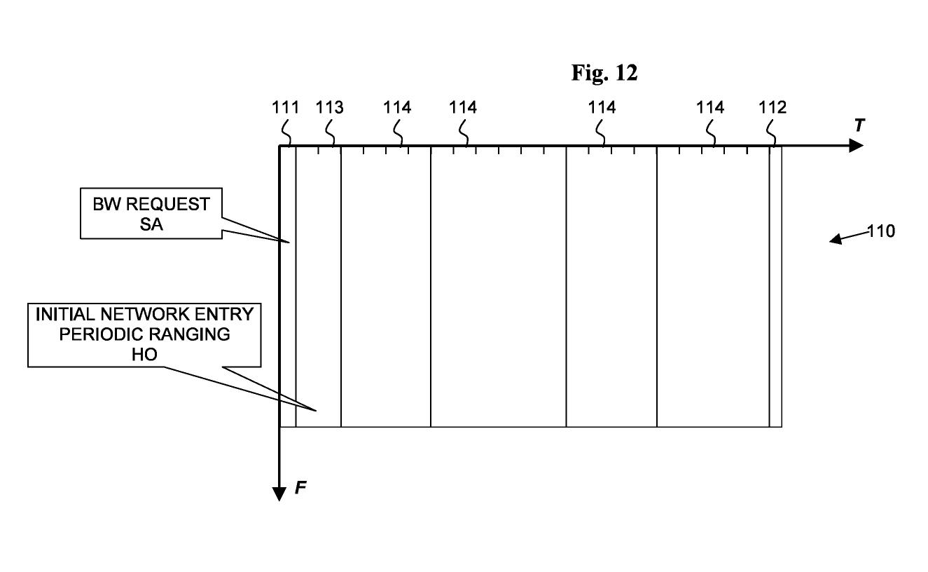

Reference is now made to FIG. 12, which is a simplified diagram of an example of frame allocation in Rx mode according to an embodiment of the invention.

As seen in FIG. 12, an Rx frame 110 contains the following allocations:
a receiving preamble part 111 at the beginning and a transmission transition gap (TTG) 112 at the end;
contention area 113; and
one or more payload sections 114.

In the Rx frame 110 of FIG. 12, the payload allocations 114 can be per whole OFDM frame, or, alternatively, in rectangular forms as per IEEE802.16e using OFDMA rectangular allocations.

Based on the IEEE802.16e standard, the mesh-node combines base-station functionality with user terminal functionality. Thus, mesh nodes can communicate with each other. The base-station (superordinate) and the user-terminal (subordinate) module can communicate between themselves via Ethernet, Dual Port RAM (DPR) or any other protocols.

The base-station (superordinate) and the user-terminal (subordinate) modules use different frequency bands (F1 and F2) defined by the mesh node processing part, enabling the functionality of the dual units. Reducing interference between two mesh-nodes in the same frequency is achieved by transmitting on different permutations (BS unit) calculated by Eq. 1:

$${P}_{j} = random ( 3 ) \vert J = 1 \\ {P}_{j} = if ( mod ( J , 2 ) == 0 ) {〈}_{{P}_{j - 1}}^{mod ( {P}_{j - 1} + 1 , 3 )} \vert J > 1 \qquad Eq . 1$$

where:
j denotes the mesh-node layer, where j==1 is the first (root) layer, and
p denotes the base-station (superordinate) permutation

It is therefore appreciated that frame structures as described above preferably contain a one or more transmission zones (Tx zone) which preferably include:
a data transmission to a superordinate; and
one or more data transmissions to at least one subordinate.

Therefore enabling a network node to transmit the data to its superordinate node and to its subordinate nodes in the same time.

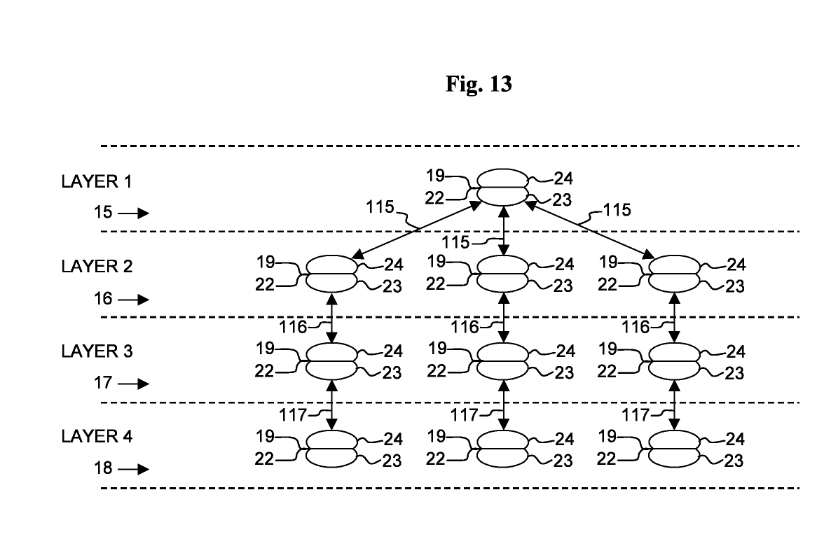

Reference is now made to FIG. 13, which is a simplified diagram of a mesh network PHY topology according to an embodiment of the invention.

As seen in FIG. 13, the subordinate part of a mesh-node scans all F1 and F2 frequencies and sends the scan results to the mesh node “network manager” software and to the host interface software. The mesh node Network Manager is preferably a software program described below.

As seen in FIG. 13:

The connectivity between layer 1 (15) and layer 2 (16), designated by numeral 115, uses frequency band 1 (F1) and permutation K;

The connectivity between layer 2 (16) and layer 3 (17), designated by numeral 116, uses frequency band 2 (F2) and permutation K;

The connectivity between layer 3 (17) and layer 4 (18), designated by numeral 117, uses frequency band 1 (F1) and permutation (K+1)% 3.

The mesh node can initiate a Frequency Change command or a Hand-Over (HO) command to both the base-station (superordinate) and the terminal (subordinate) modules of the mesh node.

The Frequency change command causes the base-station (superordinate) and/or the terminal (subordinate) module to change the working frequency when the limitation is that each unit uses a different frequency (F1/F2), within the F1/F2 band, any frequency is allowed.

The hand-over command causes the terminal module to hand-over from the currently serving mesh node to the target mesh node. The HO process is implemented by the terminal module of a mesh node may cause a change of the frequency of the superordinate of this mesh node.

The mesh-network indicates (advertises) the network level (layer number) in the preamble ID. The base-station (superordinate) preamble ID is set according to Eq. 2:

Preamble=P+Level*16+Subordinateᵢ Eq. 2

where i is a subordinate index defined by a superordinate in subordinate initial network entry.

It is appreciated that the number 16 is an example, and can be replaced by any suitable number.

The following traffic considerations are applicable to the selection of the “best” path for a data flow:
Carrier to noise ration (C/N): the lower the C/N the smaller the throughput, that is, less bytes per slot (less efficient modulation).
Hops (number of layers traversed)
Bottlenecks: avoiding congestion and potential delays.

A weight function is used to calculate the cost of transmitting information via a data path. The result of the weight function is termed “price”. A minimal price is evident of the most efficient path, with minimal overhead for the mesh network.
Air resource: the air resource is one or more slots as defined by WiMAX and IEEE 802.16. The better the channel C/N the higher is the number of byte per slot that can be transmitted.
Load: a mesh node has limited resources (frequency, bandwidth, processing power, etc.), the data path should bypass a loaded unit.
Delay: depending on the numbers of hops, and on the load of the mesh nodes along the data path.
Interference: neighboring mesh-nodes that share the same sub-carrier and symbol increase the interference.
Further criteria might be used and calculated, as the proposed “price” calculation is not limited to the above mentioned criteria.

There is a tradeoff between choosing a mesh-node with the best C/N that costs minimum slots and choosing a mesh-node in a higher layer or a mesh-node with lesser load or lesser interference

The best equilibrium (break even) to achieve the best traffic at the mesh network is affected by the following function parameters:
Numbers of slot needed to transmit single byte.
Numbers of hops.
Unit level.
Unit load (traffic and sons).
Interference (influence of the neighbors).
Bottleneck node in data path.
Other criteria may be considered such as processing power of a node, antenna technologies of a node, power consumption, etc.

The Path resource function is provided by Eq. 3:

$$Reff = {\sum }_{i = 1}^{n} \frac{1}{{RFQ}_{i}} , [ Slots \text{/} byte ] , \qquad Eq . 3$$

where:
Reff—number of slot cost 1 byte to transmit all the path;
RFQ—number of byte per slot transmitted between two units, depending on the C2N at the channel between them;
n—number of hops in the path (Level 1).

The Obstruct Node function is thus given by Eq. 4:

$$R\_obst = min ( \frac{R\_free \_slot}{SonUnit \cdot nb\_nbr \cdot ( max Level - level\_nb + 1 )} ) \qquad Eq . 4$$

where:
R_free_slot—slot free to transmit a message depending on the number of units associated with the test unit and the neighbors' interference;
SonUnit—number of offsprings;
nb_nbr—number of neighbor units;
maxLevel—number of levels in branch (lower layer);
level_nb—unit level.

Therefore the Price Function is given by Eq. 5:

$$price = \frac{nb\_hop * {R}_{eff}}{R\_obst} \qquad Eq . 5$$

The Role Selection algorithm is therefore:
Weight function algorithm is used online and offline:
   a. Online by embedding:
      i. Calculate the “price” for each BS after scan period and select the BS with lowest price.
      ii. Get reports from all sub-ordinates RF units and optimize the network so all roots has minimal cost.
   b. Online by simulation tools
      Used to generate test vector to software
   c. Offline by simulation tools
      Used to test that the RSA got the best results by comparing it to the offline prices.

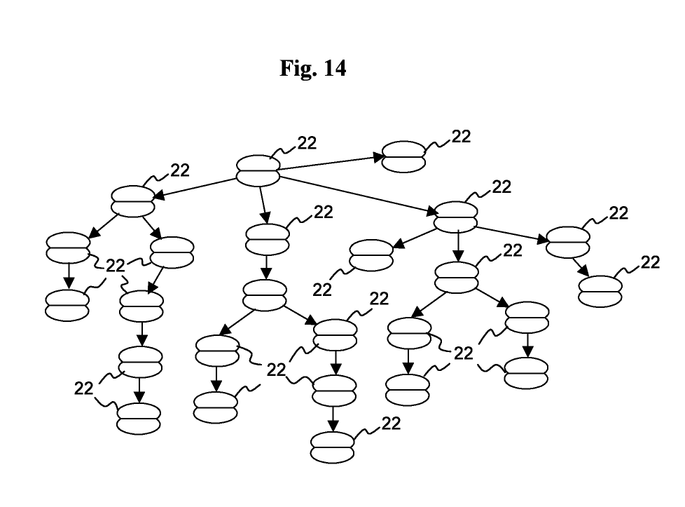

Reference is now made to FIG. 14, which is a simplified diagram of a slot request in a mesh network according to an embodiment of the invention.

When more than one mesh-node has to implement the same decision, a priority rule is added to avoid action taken by more than one mesh-node, causing a ping-pong event. The priority rule is calculated according to the Preamble ID calculation. The lowest level and ID have the higher priority according to Eq. 2. The mesh-node uses the priority rule in the following cases:
Changing frequency: When a subordinate node detects a new network that is using the same frequency band, the mesh-node with a higher ID changes the working frequency band.
Changing working level (permutation): When a subordinate node detects is about to be handed over from a first subordinate to a second subordinate in the same level, the mesh-node with a higher ID connects to the lower ID.

Scanning

The scanning process of a mesh-node is implemented by the subordinate component MS. The following lists the types of scanning processes:
Initial scanning: Implemented after power up/reset or whenever the subordinate MS and superordinate BS units are not functioning in the link.
Periodic scanning: Implemented when subordinate MS is connected to the Mesh Network.
Idle Scanning: Implemented when subordinate MS is not connected to the Mesh Network.

R1/Modem Scanning

Within the scanning processes listed above the R1/modem scanning process segment is the same for all. R1/modem scanning is implemented by the following steps:
1 Changes the RF frequency to the required scan frequency, it may be the same frequency as working frequency.
2 Measures the RSSI and CINR of all of the received preambles for N frames according to the scan type.
3 Calculates the RSSI and CINR average.
4 Returns to the working frequency.
5 Adjusts the AGC according to the working BS.

Initial Scanning

The initial scanning process is implemented after power up/reset event occurs. In this state, both subordinate MS and superordinate BS units are not functioning. The initial scanning process performs the following steps:
1 Initiates both mesh-node units' software, hardware and modem.
2 Network management software initiates scanning table and activates scanning
3 Enables subordinate unit RF and modem.
4 Implements R1/modem scanning per entry according to the Scanning table.
5 Returns scanning result to network entry procedure.
6 Changes subordinate state to idle.

Periodic Scanning

The periodic scanning process is implemented when the subordinate MS is connected to the Mesh Network. In this state, the subordinate MS and superordinate BS units transmit on different frequencies. In periodic scanning, the subordinate MS scans the working frequency every frame and records the RSSI and CINR for all BSs according to the Preamble ID calculation. The scanning process of the other frequency includes the following steps:
1 Disables the superordinate unit preamble transmission.
2 Implements the R1/modem scanning per entry on the second frequency.
3 Returns scanning result to Network entry.
4 Changes subordinate working frequency.

Idle Scanning

Idle Scanning process is implemented when the subordinate MS is not connected to the Mesh Network. The process is the same as periodic scanning if the superordinate unit is scanning its frequency and is the initial scan when scanning the other frequency.

Power Up

After power up, the mesh-node superordinate base-station RF is inactive and the mesh-node subordinate MS implements initial scanning on the all of the configured frequencies.

If during the scanning process, one or more superordinate base-stations are found, the Network Management software instructs the subordinate unit of the mesh-node to connect to the Best superordinate, as discussed below. The subordinate implementing the initial network entry process and after completion, the Network Manager activates the superordinate unit with a different frequency and Preamble ID. Further details are available in the IEEE802.16e 2005 standard.

If during the scanning process no superordinate base-station is found, the network management software instructs the subordinate unit of the mesh-node to change to idle mode and activates the superordinate unit with the first frequency and first Preamble ID.

Best Base-Station Selection

While the mesh-node operates the MS subordinate module it implements a periodical network discovery process using the R1 (air interface) scan process. The discovery process is initiated by the network manager software, according to a pre-configured time interval and MS subordinate link quality as discussed above. In some scan processes, the MS subordinate discovers that more than one base-station (superordinate) is available in the RF connectivity. The base-station selection process is implemented using the following steps:
1 Reorders the base-stations according to the following priorities (lowest to highest):
   Idle base-station is reordered according to DL CINR
   Active target base-station and serving base-station
2 Selects the BS with higher priority.

Preamble ID Change

The Preamble ID change is implemented by WiMAX R1 MAC and the modem. The process is initiated by the Network Management software when the following situations occur:
BS unit of the mesh-node is activated.
MS unit hand-over to new superordinate node.
Preamble collision with another BS unit occurs (see the use cases below).
Network layer reordering is required (see the use cases below).

The Preamble ID change is implemented in the following steps:
1 Sends preamble change message to all BS subordinates network management software, declaring the Preamble ID change at frame X, where X is greater than the current frame by +5.
2 On Frame X-1, superordinate BS network management software and all its subordinate MS network management software instructs the R1 MAC to change the Preamble ID in the next frame.
3 If the subordinate mesh-node units also have BS superordinate functionality, the network management software repeats Steps 1 and 2.

Frequency Change

WiMAX R1 MAC and modem implement frequency change. The process is initiated by the Network Management software when the following situations occur:
BS unit of the mesh-node is activated
MS unit hand-over to new superordinate unit
Frequency collision with other BS unit occur (see the use cases below)
Network layers reorder is needed (see the use cases below)

The frequency change may be implemented in the following steps, obviously other values can be used:
1 Send preamble change message to all BS subordinate Network Management software, declaring the Preamble ID change at frame X, where X is greater than the current frame by +5.
2 On Frame X-1, superordinate BS Network Management and all its subordinate MS Network Management instruct the R1 MAC to change the frequency in the next frame.
3 If the subordinate mesh-node units also have BS functionality, the Network Management software repeats Steps 1 and 2.

As an example of implementation, Frequency change time is five frames per hop and two frames between levels, therefore, total change time is 5+2*(level-2), meaning, when level 5 changes frequency it takes 11 frames at approximately ˜55 msec.

Broadcasting Messages

Typically, DL and UL MAPs are not necessarily broadcasted in every frame in order to decrease the power consumption. However, preamble is preferably sent in each frame, and DL/UL MAPs may only sent when there is a subordinate, or all frames when there is no need for saving mesh node power, e.g. when the mesh node is powered by an external power system, such as a vehicle power system.

DCD/UCDs (as defined in WiMAX) are sent whenever required, usually approximately every one second if there are subordinates.

Hand-Over Process

Hand-over process aim is to change super-ordinate with minimal down time. A subordinate initiate the HO process when, but not limited to:
Link quality to serving super-ordinate is poor and potentially the link to other super-ordinate (target superordinate) is better in X dB according to the value advertise by BS in DCD message
Network optimize algorithm decided to change network topology (RS Algorithm)

The subordinate HO is made from F2 to F1 (frequency) or F1 to F2 (frequency) according to super-ordinate operating frequency. Before HO process the MS need to learn neighbor superordinate information i.e. preamble ID, working frequency, levels etc.

Software Architecture

Mesh Node software may be built from the following, but not limited to:
Switch Thread: This thread implements the 2nd and 3rd layer switch functionality. Switch thread is activated according to the traffic from ports and maintenance interval.
Host Thread: This thread implements the Host Interface functionality. Host thread is activated by the socket when the client (host) sends requests to the server and maintenance time interval.
Network Thread: This thread implements some of the Network Management functionality. Network thread is activated by the maintenance time interval.

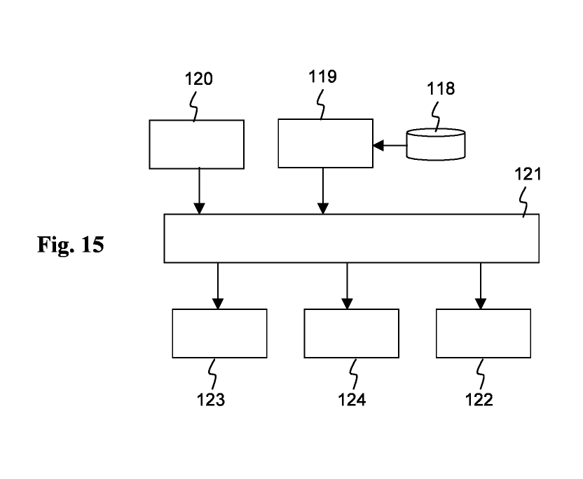

Reference is now made to FIG. 15, which is a simplified block diagram of a switching configuration according to an embodiment of the invention.

The mesh network devices preferably contains the following components:
RF System: typically supports required channel BWs in desired spectrums.
R1 Modem: Implements IEEE802.16 family of standards modem according to WiMAX profile.
R1 MAC: Implements IEEE802.16 family of standards MAC according to WiMAX profile.
2nd Layer Switch: Implements a dynamic switch.
3rd Layer Switch: Implements a dynamic switch.
CPU Communication: Implements communication between subordinate and superordinate of a mesh node.
Network Management: Implements general management of a mesh-node, such as Mesh Network traffic management and switches configuration.
Host Interfaces: Implements simple interfaces to host applications (meaning configuration, trace and debug tools).

Mesh node network manager are typically be implemented on both the subordinate and superordinate (MS and BS) modules, such as MS and BS baseband modules, or MS and BS devices, or MS and BS processors. These modules, devices or processors are preferably interconnected with each other. Alternatively, MS and BS functionalities are implemented in a single chip set. When the mesh node includes two interconnected modules, devices or processors, Ethernet or dual port RAM or any other appropriate interface can be used to provide the interconnection. The RF system and R1 Modem layers are preferably implemented by hardware and configured by software, while the remaining layers are implemented by software on one or both processors of the MS and BS modules.

Mesh software includes 2nd/3rd layer switch, network management and host interfaces, as described below:

Switch layers run on both subordinate and superordinate (or MS and BS) modules or processors, while the network management and host interfaces may run on a superordinate's module/processor, or superordinate module/processor or on both processors/modules.

As seen in FIG. 15 as an example of a switching configuration preferably containing:
an ARP Table 118;
a Network Management module 119;
one or more Host Interface modules 120;
a 2^{nd}/3^{rd} layer switch system 121;
a superordinate R1 Port 122;
a subordinate R1 Port 123;
a host interface port 124.

2nd/3rd Layer Switch

The mesh network software is preferably implemented using the WiMAX concept. The mesh network has a point-to-multi-point topology with the superordinate module in each mesh node operating as a cell concentrator. From the mesh software point of view, the mesh-node is a three-port 2nd/3rd layer switch equipped with management software.

The mesh node (MN) software preferably includes a three ports 2nd/3rd layer switch that runs on both mesh-node units. The switch's ports are subordinate/superordinate of the WiMAX R1 MAC and the host processor. The switch's task is to learn from IP/all port devices (source MAC address), to select the destination port according to the destination IP address and to divert the message to an external port. Preferably, both subordinate and superordinate modules of the mesh node contain the same switch code and database, keeping this database synchronized between the two processors or modules.

The mesh node may implement two switch layers, 2nd layer switch and 3rd layer switch. Each switch has four physical ports namely, a host processor port, a local IP stack port, a subordinate port and a superordinate port.

A mesh node may contain two switch layers: a 2nd layer switch and a 3rd layer switch. Each switch preferably contains four physical ports: a host processor port, a local IP stack port, a subordinate port and a superordinate port.

Traffic from all ports is initially handled by a distributed switch, which finds the destination port according to an IP Destination MAC address. After the destination port is set, the Ethernet header is modified and the mesh node sends the packet to the destination port.

Network Management

The Network Management software controls the Mesh Network operation and topology, preferably by creating a virtual entity implemented on all Mesh Nodes (MN) and controlling the WiMAX R1 MAC/PHY. Each Network Manager and Mesh Network communicates with other Network Managers in the Mesh Network, preferably by creating a virtual LAN. The Network Management tasks are, but not limited, to the following:
Control WiMAX R1 units state by changing each mesh-node unit state to one of the following states:
Network entry:Unit attempts to connect to Mesh Network.
Active: Unit is active and connected to the Mesh Network.
Standby: Unit is active but does not have network connection.
Handover: Unit changes location in the Mesh Network.
Sleep: Unit is in power save mode while connected to the Mesh Network.
Idle: Unit is in power save mode.
Power down: Unit is disabled by Network Management (only UT or BS).

Create communication link with all other Mesh Nodes Network Managers in the Mesh Network.

WiMAX R1 Provision Management (PM), creates service flows for each new subordinate mesh-node device according to pre-configure rules.

WiMAX R1 Handover (HO) Control, implements all tasks defined by WiMAX to enable mesh-node HO process from one BS to another. This task enables HO and accelerates the HO process without having BS-to-BS communication.

Network Optimization, periodically initiate network scanning and, if needed, change mesh-node position in the network according to signal quality and neighbor mesh-node hierarchy. The Network Optimization tries to minimize the number of hops in the network without decreasing network throughput due to pure wireless link conditions.

Anti Jamming Handling, configures and controls the mesh-node units to implement the anti jamming configuration of host processor.

Host Interfaces

The goals of the mesh node (MN) software host interfaces are:
Single gateway to host Man Machine Interfaces (MMI) for the purpose of:
   Configuration;
   Operation measurements;
   Network maintenance;
   Software updates.
Fault isolation
Operation control:
   Privacy;
   Anti Jamming;
   Above WiMAX management;
Data/Control plane interface between the Host and Mesh air interface.

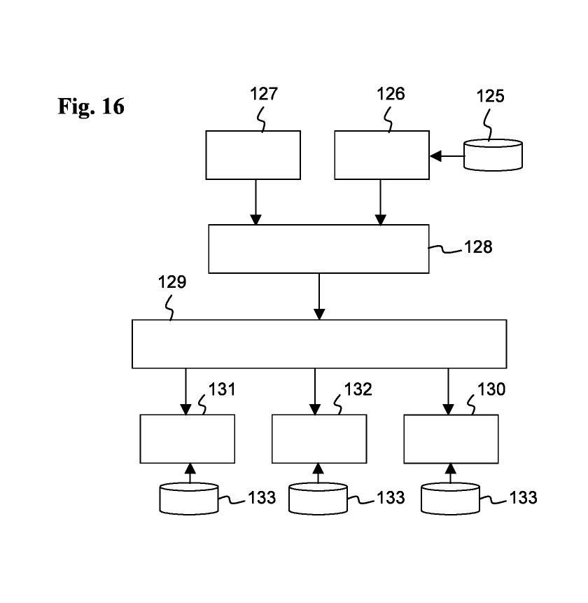

Reference is now made to FIG. 16, which is a simplified block diagram of another switching configuration according to an embodiment of the invention.

As seen in FIG. 16 as another example of a switching configuration preferably containing:
an ARP Table 125;
a Network Management module 126;
one or more Host Interface modules 127;
header change 128;
a 2^{nd}/3^{rd} layer switch system 129;
a superordinate R1 Port 130;
a subordinate R1 Port 131;
a host interface port 132;
MAC 133.

It is expected that during the life of this patent many relevant Communication devices and systems will be developed and the scope of the terms herein, particularly of the terms “SNR”, “SINR”, “CINR”, MIMO, “spatial multiplexing” and “spatial diversity”, is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the invention.

1. A mobile base-station operative in a wireless communication network, wherein said wireless communication network comprises network layers and wherein said mobile base-station comprises negotiating functionality for negotiating at least one of a layer parameter and a cell parameter with a neighboring base-station.

2. A mobile base-station according to claim 1 wherein said at least one of a layer parameter and a cell parameter comprises at least one of:
frequency band (F1, F2, etc.);
segmentation, or sub-band (F1a, F1b, etc.);
sub-carrier grouping and./or allocation;
sub-carrier sub-grouping and or allocation;
sub-channelization;
permutation;
coding;
timing;
preamble ID; and
transmission power.

3. A mobile base-station according to claim 2 additionally comprising at least one of:
a permutation calculation module for calculating said permutation according to a layer number; and
a preamble calculation module for calculating said preamble according to a layer number.

4. A method of wireless communication in a communication network comprising a plurality of network nodes wherein at least one of said network nodes is mobile, the method comprising:
arranging said communication network according to a layered network architecture forming a plurality of network layers;
arranging said plurality of network nodes in said network layers; and
assigning at least one of a network parameter and a cell parameter to at least one of said network nodes.

5. A method according to claim 4 wherein said at least one of a network parameter and a cell parameter comprises at least one of:
frequency band (F1, F2, etc.);
segmentation, or sub-band (F1a, F1b, etc.);
sub-carrier grouping and./or allocation;
sub-carrier sub-grouping and or allocation;
sub-channelization;
permutation;
coding;
preamble ID; and
transmission power.

6. A method according to claim 4 wherein said step of assigning at least one of a network parameter and a cell parameter to at least one of said network nodes comprises negotiating said at least one of a network parameter and a cell parameter with at least one other network node.

7. A method according to claim 4 wherein said network node is a base-station.

8. A method according to claim 4 wherein said plurality of network layers comprises at least a first, a second and a third layer and additionally comprising at least one of the steps of:
receiving, by a network node at said second layer, a data transmission from a network node is said first layer and transmitting said data transmission to a network node is said third layer; and
receiving, by a network node at said second layer, a data transmission from a network node is said third layer and transmitting said data transmission to a network node is said first layer.

9. A method according to claim 8 wherein said network node is a relay node.

10. A method according to claim 4 wherein said communication network is at least one of:
an OFDMA network;
a network complying to any of IEEE802.16 standards and its derivatives;
a WiMAX network; and
an LTE network.

11. A method according to claim 4 wherein said communication network uses communication technology comprising sub-carriers; and
wherein said sub-channels are grouped to form segments;
additionally comprising the step of:
allocating segments to layers to achieve frequency orthogonality between layers.

12. A method according to claim 11 additionally comprising the steps of:
dividing said segment into at least two groups of sub-channels to form sub-segments; and
allocating said sub-segments to said network nodes of said layer to achieve orthogonality between said network nodes.

13. A mobile node for a wireless communication network, said mobile node comprising:
a terminal module operative to communicate with at least one of a base-station, and a base-station module of another mobile node of said wireless communication network; and
a base-station module connected to said terminal module and operative to communicate with at least one user-terminal of said plurality of user-terminals of said wireless communication network;
wherein said base-station module is operative to negotiate cell parameters with neighboring base-station modules.

14. A mobile node according to claim 13 wherein said cell parameters comprises at least one of:
frequency band (F1, F2, etc.);
segmentation, or sub-band (F1a, F1b, etc.);
sub-carrier grouping and./or allocation;
sub-carrier sub-grouping and or allocation;
sub-channelization;
permutation;
coding;
timing;
preamble ID; and
transmission power.

15-50. (canceled)
